(19) United States
(12) Patent Application Publication
(10) Pub. No.: US 2008/0303982 A1
(43) Pub. Date: Dec. 11, 2008

(54) Double-sided organic light emitting display and driving method thereof

(76) Inventors: Dong-un Jin, Suwon-si (KR); Hui Nam, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/073,316

(22) Filed: Mar. 4, 2008

(30) Foreign Application Priority Data
Jun. 5, 2007 (KR) 10-2007-0054899

(51) Int. Cl. G09G 3/30; H05B 33/00; G02F 1/13357

(52) U.S. Cl. 349/69; 313/504; 345/84

(57) ABSTRACT

A method of driving a double-sided light emitting display may include driving a panel to emit light toward a first surface and a second surface thereof, the panel including a first light controlling panel on the first surface thereof, a second light controlling panel on the second surface thereof, and pixels formed therein, and controlling transmission of light through each of the first light controlling panel and the second light controlling panel.

### BACKGROUND OF THE INVENTION

1. Field of the Invention

Embodiments relate to a double-sided organic light emitting display, and a driving method thereof. More particularly, embodiments relate to a double-sided organic light emitting display capable of displaying different images on multiple, e.g., two, sides of an organic panel, and driving method thereof.

2. Description of the Related Art

Various types of flat panel displays, which are lighter in weight and smaller in volume relative to cathode ray tubes, are being developed. For example, organic light emitting displays having excellent physical properties, e.g., relatively higher luminous efficiency, relatively higher luminance, relatively wider viewing angle, and a relatively faster response speed are being researched and developed. Such organic light emitting displays are expected to contribute highly to the development of portable electronic instruments because they are relatively lighter in weight and may be driven at low power.

Various types of organic light emitting displays are being developed, e.g., top-emission organic light emitting displays, bottom-emission organic light emitting displays and dual-emission organic light emitting displays. Such displays depend on the forwarding direction of the light. Dual-emission organic light emitting displays are advantageous by enabling information to be displayed on two sides of a screen using a single panel. However, current dual-emission organic light emitting displays may not be employed in many applications in a variety of fields because only the same information may be displayed on two sides of a screen.

### SUMMARY OF THE INVENTION

Embodiments of the invention are therefore directed to a double-sided organic light emitting display and a driving method thereof, which substantially overcome one or more of the problems due to the limitations and disadvantages of the related art.

It is therefore a feature of an embodiment of the invention to provide a double-sided light emitting display capable of displaying different images on different sides of a panel.

It is therefore a separate feature of an embodiment of the invention to provide a method of driving a double-sided light emitting display capable of displaying different images on different sides of a panel.

It is therefore a separate feature of an embodiment of the invention to provide a double-sided organic light emitting display capable of displaying a first image on a first side of an organic panel and a second image on a second side of the organic panel, where the first image is different from the second image.

It is therefore a separate feature of an embodiment of the invention to provide a method of driving a light emitting display capable of displaying a first image on a first side of an organic panel and a second image on a second side of the organic panel, where the first image is different from the second image.

At least one of the above and other features and advantages of the invention may be realized by providing a double-sided light emitting display, including a panel including a plurality of pixels adapted to emit light toward first and second surfaces of the panel, a first light controlling panel on the first surface of the panel, the first light controlling panel being adapted to control transmission of the light emitted toward the first surface, and a second light controlling panel on the second surface of the panel, the second light controlling panel being adapted to control transmission of the light emitted toward the second surface.

The double-sided light emitting display may be a double-sided organic light emitting display, and the panel is an organic panel may include at least one organic light emitting diode. At least one of the first light controlling panel and the second light controlling panel includes a liquid crystal panel.

The first light controlling panel and the second light controlling panel both include a liquid crystal panel, and are adapted to be set in a light transmitting state or a black state based on whether one of a ground power source voltage or a driving power source voltage having a higher voltage value than the ground power source is supplied thereto.

At least one of the first light controlling panel and the second light controlling panel includes one of E-ink and an electrochromatic layer. The display may further include a scan driver adapted to sequentially supply a respective scan signal to scan lines in the organic panel, and a data driver adapted to supply a respective data signal to data lines in the organic panel.

The first light controlling panel may be in a light transmitting state when the second light controlling panel is in a black state, and the first light controlling panel may be in a black state when the second light controlling panel is in a light transmitting state such that a first image may be displayed on a first side of the display corresponding to the first surface and a second image may be displayed on a second side of the display corresponding to the second surface. The first image may be different from the second image.

During an i-th driving period, where is an odd number or an even number, the first light controlling panel may be in a light transmitting state and the second light controlling panel may be in a black state, and during an i+1-th driving period, the second light controlling panel may be in a light transmitting state and the first light controlling panel may be in a black state.

The data driver may be adapted to control the respective data signals supplied during the i-th driving period to display the first image and to control the respective data signals supplied during i+1th driving period to display the second image.

A driving frequency of the scan driver and the data driver may be set to a frequency of at least 60 Hz when the first and second images are displayed on the first and second sides of the display. The first surface may oppose and overlap with the second surface.

At least one of the above and other features and advantages of the invention may be separately realized by providing a method of driving a double-sided light emitting display, the method including driving a panel to emit light toward a first surface and a second surface thereof, the panel including a first light controlling panel on the first surface thereof, a second light controlling panel on the second surface thereof, and pixels formed therein, and controlling transmission of light through each of the first light controlling panel and the second light controlling panel.

The double-sided light emitting display may be a double-sided organic light emitting display, and the pixels each include an organic light emitting diode. The first surface may oppose and overlap with the second surface.

Controlling may include during a first time period, setting the first light controlling panel to be in a light transmitting state and the second light controlling panel to be in a black state, and during a second time period, setting the first light controlling panel to be in a black state and the second light controlling panel to be in a light transmitting state such that a first image is displayed on a first side of the display corresponding to the first surface and a second image is displayed on a second side of the display corresponding to the second surface.

The first time period may be an i-th driving period, where is an odd number or an even number, and the second time period may be an i+1-th driving period. Driving may include driving the panel at a frequency of at least 60 Hz to display a first image on a first side of the display corresponding to the first surface and to display a second image on a second side of the display corresponding to the second surface.

Driving may include driving the panel at a frequency of at least 60 Hz to display a first image having an image quality corresponding to at least 30 Hz on a first side of the display corresponding to the first surface and to display a second image having an image quality corresponding to at least 30 Hz on a second side of the display corresponding to the second surface.

Driving may include driving the panel at a frequency greater than 60 Hz to display a first image having an image quality corresponding to at least 30 Hz on a first side of the display corresponding to the first surface and to display a second image having an image quality corresponding to at least 30 Hz on a second side of the display corresponding to the second surface, and the image quality of the second image may correspond to a higher frequency than that of the first image.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a cross-sectional view of a double-sided light emitting display according to an exemplary embodiment of the present invention;

FIG. 2 illustrates a block diagram of the organic panel of FIG. 1 connected to drivers adapted to drive the organic panel according to an exemplary embodiment of the present invention;

FIG. 3 illustrates a cross-sectional view of a pixel of the panel shown in FIG. 1;

FIG. 4 illustrates a block diagram of the light controlling panel of FIG. 1, as coupled to external voltage sources; and

FIG. 5A and FIG. 5B illustrate diagrams of stages in an exemplary method of driving light-controlling panels of a double-sided light emitting display according to one or more aspects of the invention.

### DETAILED DESCRIPTION OF THE INVENTION

Korean Patent Application No. 10-2007-0054899, filed on Jun. 5, 2007, in the Korean Intellectual Property Office, and entitled: “Double-sided Organic Light Emitting Display and Driving Method Thereof” is incorporated by reference herein in its entirety.

Embodiments of the invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when an element is referred to as being “on” another element, it can be directly on the other element, or intervening elements may also be present. In addition, it will also be understood that when a layer is referred to as being “between” other elements, it can be the only layer between the elements, or one or more intervening elements may also be present. Further, when a first element is described as being coupled to a second element, the first element may be directly coupled to the second element, or may also be indirectly coupled, via other element(s), to the second element. Elements that are not essential to the complete understanding of aspects of the invention may be omitted for clarity. Also, like reference numerals refer to like elements throughout the specification.

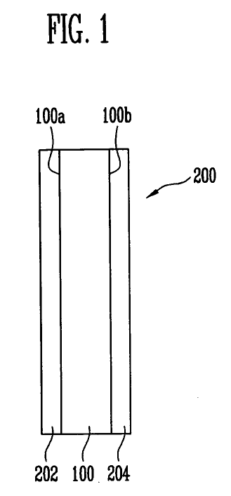

FIG. 1 illustrates a cross-sectional view of an organic double-sided light emitting display 200 according to an exemplary embodiment of the invention.

Referring to FIG. 1, the organic double-sided light emitting display 200 may include an organic panel 100, and light controlling panels 202, 204. More particularly, e.g., the organic double-sided light emitting display 200 may include a first light controlling panel 202 and a second light controlling panel 204. Each of the light controlling panels 202, 204 may be arranged on a respective side of the organic panel 100.

In the exemplary embodiment described below, the double-sided light emitting display 200 is described as an exemplary double-sided light emitting display 200 employing one or more aspects of the invention, and the organic panel 100 is described as an exemplary panel employing one or more aspects of the invention. Embodiments of the invention are not, however, limited thereto.

In some embodiments, e.g., the first light controlling panel 202 may be arranged on a first side 100a of the organic panel 100 and the second light controlling panel 204 may be arranged on a second side 100b of the organic panel 100. The first side 100a may at least partially or fully overlap with and oppose the second side 100b of the organic panel 100. The organic panel 100 may display an image using an organic light emitting diode(s).

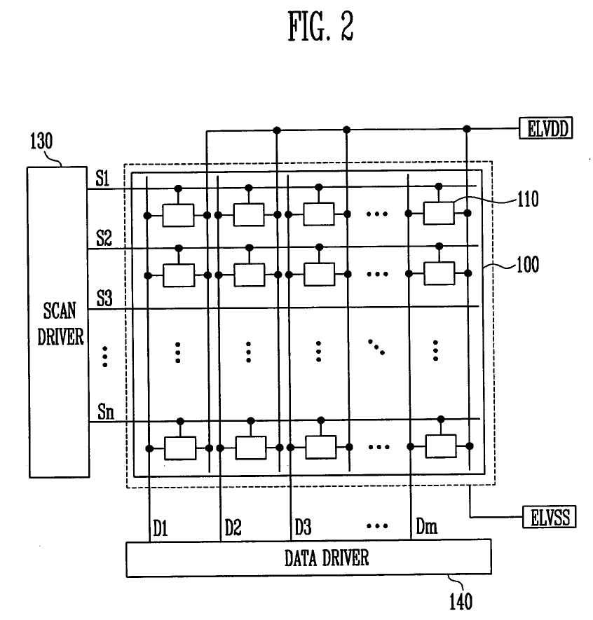

The organic panel 100 may supply a predetermined amount light to each of the first light controlling panel 202 and the second light controlling panel 204. Pixels 110 (see FIG. 2) included in the organic panel 100 may be structured such that light may be supplied to both sides of the organic panel 100. The detailed structure of the pixels 110 will be described in detail below.

Each of the first light controlling panel 202 and the second light controlling panel 204 may be selectively set to one of a light-transmitting state or a black state based on a control signal(s) supplied thereto. When the light controlling panel 202, 204 is set to a light-transmitting state, a predetermined amount of light supplied from the organic panel 100 may be emitted outward, i.e., in a direction approaching away from the organic panel 100. Therefore, a corresponding predetermined image may be observed by a viewer. When the light controlling panel 202, 204 is set to a black state, a predetermined amount of light supplied from the organic panel 100 is not emitted outward, i.e., the light controlling panel 202, 204 is controlled to block light.

In some embodiments, the light controlling panels 202, 204 may include, e.g., a liquid crystal panel(s), which may be set to a light-transmitting state or a black state corresponding to a control signal supplied thereto. In such embodiments, the liquid crystal panel may transmit (when set to a light-transmitting state) or intercept (when set to a black state) light from the organic panel 100 based on a power supply voltage supplied to the liquid crystal panel itself. Embodiments of the invention are not, however, limited to light controlling panels 202, 204 including liquid crystal panels. For example, in some embodiments, the light controlling panel 202, 204 may include electronic-ink (E-ink) or an electrochromatic layer. The E-ink or the electrochromatic layer may be controllably set to a light-transmitting set or a black state to respectively transmit or intercept light supplied from the organic panel 100.

FIG. 2 illustrates a block diagram of the organic panel 100 of FIG. 1 connected to a scan driver 130 and a data driver 140 adapted to drive the organic panel 100 according to an exemplary embodiment of the present invention.

The organic panel 100 may include a plurality of pixels 110. Each of the pixels 110 may include an organic light emitting diode (OLED) (not shown), and each of the pixels 110 may be formed at respective overlapping portions of scan lines S1 to Sn and data lines D1 to Dm. The organic panel 100 may be coupled to a first power source ELVDD for supplying a first power supply voltage VDD and a second power source ELVSS for supplying a second power supply voltage VSS. The first power source ELVDD and the second power source ELVSS may be external power sources. Each of the pixels 110 may receive the first power supply voltage VDD and the second power supply voltage VSS, and may be controlled according to a data signal supplied thereto to emit light having a predetermined luminance toward both sides 100a, 100b of the organic panel 100.

The scan driver 130 may generate a scan signal(s), and may sequentially supply the generated scan signal to the scan lines S1 to Sn. The pixels 110 of the organic panel 100 may be sequentially selected in groups, e.g., lines of the pixels 100 may be sequentially selected.

The data driver 140 may generate a data signal(s), and may supply the generated data signals to the data lines D1 to Dm, respectively. A respective data signal may be supplied to, e.g., the pixels 110 currently selected by the scan signal.

When light is to be emitted outward from, e.g., one side 100a or 100b of the organic panel 100, or one of the first light controlling panel 202 and the second light controlling panel 204, the scan driver 130 and the data driver 140 may be driven at a predetermined-one-side driving frequency (or frequency range), e.g., 60 Hz.

When light is to be emitted outward from, e.g., both sides 100a and 100b of the organic panel 100, or both the first light controlling panel 202 and the second light controlling panel 204, the scan driver 130 and the data driver 140 may be set to a predetermined dual-side-driving frequency (or frequency range), e.g., at least 60 Hz. More particularly, in some embodiments, when light is to be emitted outward from both sides 100a, 100b of the organic panel 100, or both the first light controlling panel 202 and the second light controlling panel 204, the first light controlling panel 202 and the second light controlling panel 204 may be alternately set to a light-transmitting state and a black state. For example, in such embodiments, during an i-th (i is an odd or an even number) frame or sub-frame, the first light controlling panel 202 may be set to a light-transmitting state and the second light controlling panel 204 may be set to a black state, and during an i+1-th frame or sub-frame, the first light controlling panel 202 may be set to a black state and the second light controlling panel 204 may be set to a light-transmitting state during an i+1th frame or sub-frame. In such embodiments, if, e.g., the data driver 140 supplies data signals corresponding to a first image during every i-th frame or sub-frame and data signals corresponding to a second image during every i+1-th frame or sub-frame, the first image may be displayed on the first side 100a of the organic panel 100 via the first light controlling panel 202, and the second image may be displayed on the second side 100b of the organic panel 100 via the second light controlling panel 204. Further, in such embodiments, if the first image is different from the second image, different images may be displayed on the two sides 100a, 100b of the organic panel 100.

In cases where light is to be emitted outward from both sides 100a, 100b of the organic panel 100, if the scan driver 130 and the data driver 140 are driven at, e.g., 60 Hz, a respective image corresponding to 30 Hz may be displayed on the respective side 100a, 100b of the organic panel 100. Thus, image quality may be reduced.

In some embodiments of the invention, to maintain and/or improve image quality, the predetermined dual-side-driving frequency may be set to be higher than, or more particularly, at least twice that of, a minimum driving frequency required for achieving a desired image quality on each side 100a, 100b of the organic panel 100. For example, if a driving frequency of at least 60 Hz is required to display a respective image having a desired image quality on one side 100a or 100b of the organic panel 100, a driving frequency twice that of the minimum driving frequency of 60 Hz, i.e., 120 Hz, may be employed to display the respective images on the respective two sides 100a, 100b of the organic panel 100.

More particularly, e.g., if the scan driver 130 and data driver 140 are driven at 120 Hz, then a respective image corresponding to a driving frequency of 60 Hz may be displayed on each of the two sides 100a, 100b of the organic panel 100. If the driving frequency is set to 120 Hz, then 120 frames are driven during one second. In this case, light corresponding to 60 frames may be emitted toward each of the sides 100a, 100b of the organic panel 100 by alternately changing the first light controlling panel 202 and the second light controlling panel 204 between a light-transmitting state and a black state. Therefore, assuming a desired driving frequency of 60 Hz for each image, by driving the scan driver 130 and the data driver 140 at 120 Hz, both sides of the organic panel 100 may display respective images without any deterioration in image quality.

Embodiments of the invention are not, however, limited to a driving frequency of 120 Hz when displaying a respective image on each of the sides 100a, 100b of the organic display 100. In some cases, e.g., light corresponding to 30 frames a second may be sufficient to display images of a suitable or desired quality, and thus, the scan driver 130 and the data driver 140 may be driven at a driving frequency of 60 Hz. In other cases, e.g., a driving frequency greater than 60 Hz, e.g., 80 Hz, may be employed for displaying respective images on the sides 100a, 100b of the organic panel 100. If the driving frequency is set to 80 Hz, by alternating the first light controlling panel 202 and the second light controlling panel 204 between a light emitting state and a black state, the light corresponding to 40 frames may be emitted toward each of the sides 100a, 100b of the organic panel 100.

Accordingly, some embodiments of the invention may provide a display device capable of displaying different images on different sides of a single panel. Some embodiments of the invention may provide a method of driving a display device so as to display different images on different sides of a single panel of the display device. More particularly, embodiments of the invention may enable image quality to be maintained and/or improved by driving the scan driver 130 and the data driver 140 at a frequency higher than, e.g., twice that of, a minimum frequency for displaying an image of a high or desired quality on one side of the panel 100.

Further, it should be understood, that in some embodiments, portions of one or more sides 100a, 100b of the organic panel 100 may be separately driven to display different images such that more than two different images, e.g., three different images, may be substantially simultaneously displayed among the two sides 100a, 100b of the organic panel 100.

In some embodiments, to display the same image or different images on dual sides of the display, while the first light controlling panel 202 is set in a light transmitting state such that light may be emitted from the side 100a of the organic panel 100, the second light controlling panel 204 may be set in a black state such that light may not be emitted from the side 100b of the organic panel 100. In embodiments, a same image may be displayed on both sides 100a, 100b of the panel 100 by setting the first and second light controlling panels 202, 204 in a light transmitting state during a same time period.

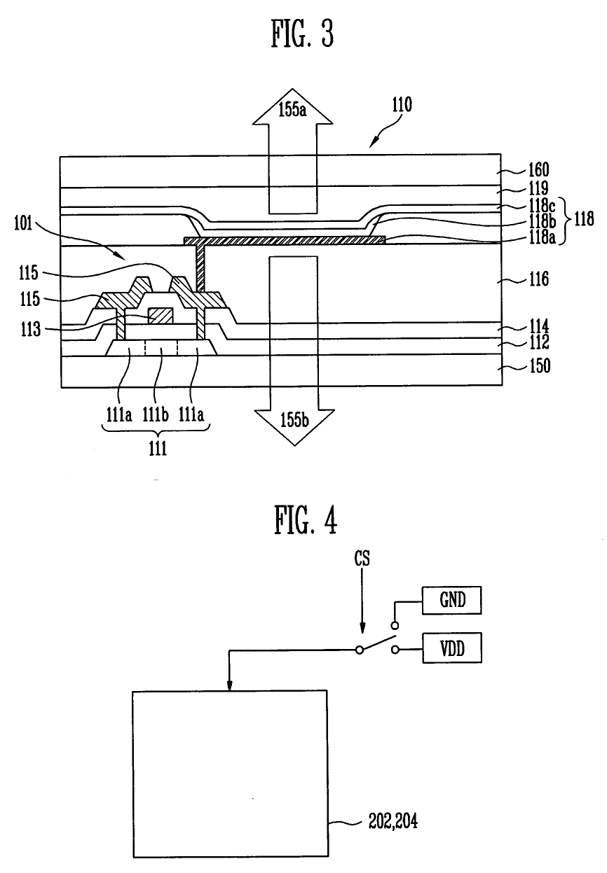

FIG. 3 illustrates a cross-sectional view of one of the pixels 110 of the organic panel 100 shown in FIG. 1. In general, the pixel 110 may include an organic light emitting diode (OLED) 118, at least one capacitor, and a transistor 101, however, for convenience, in FIG. 3 only the transistor 101 and the OLED 118 are shown. Referring to FIG. 3, the pixel 110 of the organic panel 100 may include the transistor 101 on a lower substrate 150, and the OLED 118 coupled to the transistor 101.

The transistor 101 may include a semiconductor layer 111 including source and drain regions 111a and a channel region 111b, a gate insulator 112 on the semiconductor layer 111, a gate electrode 113 on the gate insulator 112, an interlayer insulator 114 on the gate electrode 113, and a source and drain electrodes 115 on the interlayer insulator 114. The source and drain electrodes 115 may be electrically coupled with the source and drain regions 111a, respectively.

An overcoat 116 may be formed on the transistor 101. The OLED 118 may be formed on the overcoat 116.

The OLED 118 may include an anode electrode 118a that may be coupled with the transistor 101, a light emitting layer 118b formed on the anode electrode 118a, and a cathode electrode 118c formed on the light emitting layer 118b. In embodiments, to enable light to be emitted from both sides 100a, 100b of the organic panel 100, the anode electrode 118a and the cathode electrode 118c may be formed of, e.g., transparent or translucent material(s), to enable light to be transmitted there-through.

A protective layer 119 and an upper substrate 160 may be provided on the cathode electrode 118c.

Such a pixel 110 of the organic light emitting display may supply light toward a direction 155a of the upper substrate 160 and a direction 155b of the lower substrate 150. The amount of light being supplied in the directions 155a and 155b may correspond to an electric current supplied from the transistor 101 of the pixels 110. Thus, a single organic panel 100 may be employed to perform dual driving, i.e., driving both sides 100a, 100b of the organic panel 100 to display respective images thereon. The exemplary configuration of the pixels 110 shown in FIG. 3 is one exemplary embodiment of the present invention, but embodiments of the present invention are not limited thereto. For example, a configuration of dual sided pixels having various currently known shapes may be employed with aspects of the present invention.

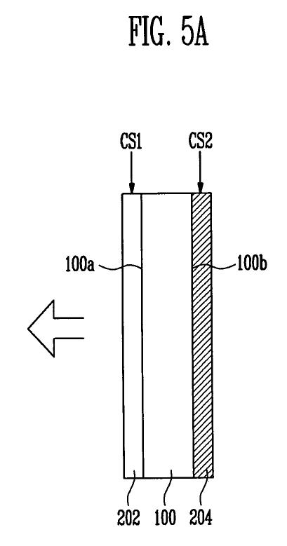

FIG. 4 illustrates a block diagram of the light controlling panel 202, 204 of FIG. 1 in a state in which it is coupled to a driving power source voltage VDD and a ground power source VSS. As discussed above, the light controlling panels 202, 204 may be controlled to operate in a black state or a light-transmitting state. The light controlling panels 202, 204 may not include any pixels themselves, and thus, may not require a driver themselves.

In some embodiments, the light controlling panels 202, 204 may be coupled so as to receive one of the driving power source voltage VDD and the ground power source GND. The driving power source voltage VDD and the ground power source GND may be externally supplied from external power sources. The light controlling panels 202, 204 may be set to a black state or a light-transmitting state based on whether the driving power source voltage VDD or the ground power source voltage GND is supplied thereto. For example, if the light controlling panels 202, 204 include a liquid crystal panel, a liquid crystal layer is present inside the light controlling panels 202, 204, and the liquid crystal layer may be changed into a black state or a light-transmitting state based on whether the driving power source voltage VDD or the ground power source voltage GND is supplied thereto. For example, the light controlling panels 202, 204 may be set to a light-transmitting state when a control signal CS having a first voltage, e.g., the driving power source voltage VDD, is supplied thereto, and the light controlling panels 202, 204 may be set to black state when the control signal CS having a second voltage, e.g., the ground power source voltage GND, is supplied thereto. The driving power source voltage VDD may have a voltage value higher than that of the ground power source voltage GND. Embodiments of the invention are not, however, limited thereto.

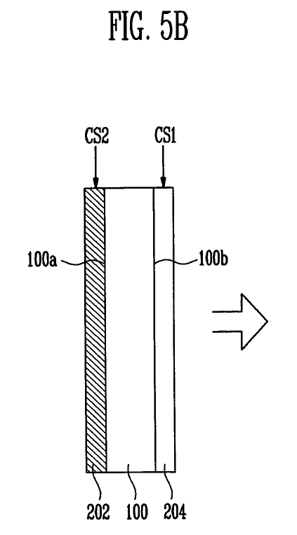

FIG. 5A and FIG. 5B illustrate diagrams of stages in an exemplary method of driving light-controlling panels of a double-sided light emitting display according to one or more aspects of the invention. Referring to FIGS. 5A and 5B, a first control signal CS1 may be supplied to the first light controlling panel 202, and a second control signal CS2 may be supplied to the second light controlling panel 204.

More particularly, referring to FIG. 5A, when the first control signal CS1 having a voltage corresponding to a light transmitting state of the first light controlling panel 202 is supplied to the first light controlling panel 202, light may be emitting outward from the side 100a of the organic panel 100. Thus, a predetermined image may be displayed on a side of the display corresponding to the side 100a of the organic panel 100. During that time, e.g., frame or sub-frame, the second control signal CS2 having a voltage corresponding to a black state of the second light controlling panel 204 may be supplied to the second light controlling panel 204 such that no light is emitted from the side 100b of the organic panel 100. Thus, during that time, no image, e.g., all black, may be displayed on a side of the display corresponding to the side 100b of the organic panel 100.

Referring to FIG. 5B, when the first control signal CS1 having a voltage corresponding to a black state of the first light controlling panel 202 is supplied to the first light controlling panel 202, no light may be emitted from the side 100a of the organic panel 100, i.e., no image, e.g., all black, may be displayed on the side of the display corresponding to the side 100a of the organic panel 100. During that time, e.g., frame or sub-frame, the second control signal CS2 having a voltage corresponding to a light emitting state of the second light controlling panel 204 may be supplied to the second light controlling panel 204, and light may be emitted outward from the side 100b of the organic panel 100. Thus, a predetermined image may be displayed on a side of the display corresponding to the side 100b of the organic panel 100.

If a respective predetermined image (the same image or different images) is displayed on both sides 100a, 100b of the organic panel 100, in some embodiments, light may be supplied to one side 100a of the organic panel 100 during an i-th frame(s) or sub-frame(s), as shown FIG. 5A, and light may be supplied to the other side 100b of the organic panel 100 during an i+1th frame(s) or sub-frame(s), as shown in FIG. 5B. Thus, in some embodiments, a single organic panel 100 may be employed to perform dual-side driving by alternately setting the first light controlling panel 202 to one of a light transmitting state or a black state and setting the second light controlling panel 204 to the other of a light-transmitting state or a black state, such that while the first light controlling panel 202 allows light to be transmitted there-through, the second light controlling panel 204 blocks light from transmitting there-through, and when the first light controlling panel 202 blocks light from transmitting there-through, the second light controlling panel 204 allows light to be transmitted there-through. More particularly, in some embodiments the first and second light controlling panels 202, 204 may alternate between a light transmitting state and a black state for each frame or sub-frame. However, embodiments of the invention are not limited thereto.

For example, in some embodiments, the first and second light controlling panels 202, 204 may be operated in a time-division manner in which one of the first and second light controlling panels 202, 204 is in a light transmitting state X % of frame(s) or sub-frame(s) in a predetermined cyclical fashion, and the other of the first and second light controlling panels 202, 204 is in a black state Y % of frame(s) or sub-frame(s) in the predetermined cyclical fashion, where Y may be equal to (100−X). For example, a cycle may correspond to every frame or sub-frame, such that during every i-th frame or sub-frame, the first light controlling panel 202 is in a light transmitting state while the second light controlling panel 204 is in a black state, and, during every i+1-th frame, the second light controlling panel 204 is in a light transmitting state, while the first light controlling panel 202 is in a black state. Embodiments of the invention are not limited thereto. For example, a cycle may be selected such that the first light controlling panel 202 is in a light transmitting state more than the second light controlling panels 202, 204, i.e., the first light controlling panel 202 is in a light transmitting state ⅔ of the time. Thus, different images resulting from a same driving frequency or a different driving frequency may be displayed on dual sides 100a, 100b of the organic panel 100.

Embodiments of the invention may provide a double-sided organic light emitting display and a driving method thereof that may display different images on dual sides of a single organic panel by employing light controlling panels on two sides of the organic panel, and controlling the transmission and interception of light from each of the two sides of the panel based on a state of the light controlling panels.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A double-sided light emitting display, comprising:
a panel including a plurality of pixels adapted to emit light toward first and second surfaces of the panel;
a first light controlling panel on the first surface of the panel, the first light controlling panel being adapted to control transmission of the light emitted toward the first surface; and
a second light controlling panel on the second surface of the panel, the second light controlling panel being adapted to control transmission of the light emitted toward the second surface.

2. The double-sided light emitting display as claimed in claim 1, wherein the double-sided light emitting display is a double-sided organic light emitting display, and the panel is an organic panel that includes at least one organic light emitting diode.

3. The double-sided light emitting display as claimed in claim 2, wherein at least one of the first light controlling panel and the second light controlling panel includes a liquid crystal panel.

4. The double-sided light emitting display as claimed in claim 3, wherein the first light controlling panel and the second light controlling panel both include a liquid crystal panel, and are adapted to be set in a light transmitting state or a black state based on whether one of a ground power source voltage or a driving power source voltage having a higher voltage value than the ground power source is supplied thereto.

5. The double-sided light emitting display as claimed in claim 2, further comprising;
a scan driver adapted to sequentially supply a respective scan signal to scan lines in the organic panel; and
a data driver adapted to supply a respective data signal to data lines in the organic panel.

6. The double-sided light emitting display as claimed in claim 5, wherein:
when the first light controlling panel is in a light transmitting state, the second light controlling panel is in a black state,
when the first light controlling panel is in a black state, the second light controlling panel is in a light transmitting state such that a first image is displayed on a first side of the display corresponding to the first surface and a second image is displayed on a second side of the display corresponding to the second surface.

7. The double-sided light emitting display as claimed in claim 6, wherein the first image is different from the second image.

8. The double-sided light emitting display as claimed in claim 6, wherein, during an i-th driving period, the first light controlling panel is in a light transmitting state and the second light controlling panel is in a black state, and during an i+1-th driving period, the second light controlling panel is in a light transmitting state and the first light controlling panel is in a black state.

9. The double-sided light emitting display as claimed in claim 8, wherein the data driver is adapted to control the respective data signals supplied during the i-th driving period to display the first image and to control the respective data signals supplied during i+1th driving period to display the second image.

10. The double-sided light emitting display as claimed in claim 5, wherein a driving frequency of the scan driver and the data driver is set to a frequency of at least 60 Hz when the first and second images are displayed on the first and second sides of the display.

11. The double-sided light emitting display as claimed in claim 1, wherein at least one of the first light controlling panel and the second light controlling panel includes one of E-ink and an electrochromatic layer.

12. The double-sided light emitting display as claimed in claim 1, wherein the first surface opposes and overlaps with the second surface.

13. A method of driving a double-sided light emitting display, the method comprising:
driving a panel to emit light toward a first surface and a second surface thereof, the panel including a first light controlling panel on the first surface thereof, a second light controlling panel on the second surface thereof, and pixels formed therein; and
controlling transmission of light through each of the first light controlling panel and the second light controlling panel.

14. The method of driving a double-sided light emitting display as claimed in claim 13, wherein the double-sided light emitting display is a double-sided organic light emitting display, and the pixels each include an organic light emitting diode.

15. The method of driving a double-sided light emitting display as claimed in claim 13, wherein the first surface opposes and overlaps with the second surface.

16. The method of driving a double-sided light emitting display as claimed in claim 13, wherein controlling comprises:
during a first time period, setting the first light controlling panel to be in a light transmitting state and the second light controlling panel to be in a black state, and
during a second time period, setting the first light controlling panel to be in a black state and the second light controlling panel to be in a light transmitting state such that a first image is displayed on a first side of the display corresponding to the first surface and a second image is displayed on a second side of the display corresponding to the second surface.

17. The method of driving a double-sided light emitting display as claimed in claim 16, the first time period is an i-th driving period, where is an odd number or an even number, and the second time period is an i+1-th driving period.

18. The method for driving a double-sided light emitting display as claimed in claim 13, wherein driving comprises driving the panel at a frequency of at least 60 Hz to display a first image on a first side of the display corresponding to the first surface and to display a second image on a second side of the display corresponding to the second surface.

19. The method of driving a double-sided light emitting display as claimed in claim 13, wherein driving comprises driving the panel at a frequency of at least 60 Hz to display a first image having an image quality corresponding to at least 30 Hz on a first side of the display corresponding to the first surface and to display a second image having an image quality corresponding to at least 30 Hz on a second side of the display corresponding to the second surface.
